(19) United States
(12) Patent Application Publication
(10) Pub. No.: US 2024/0376982 A1
(43) Pub. Date: Nov. 14, 2024

(54) Compression Ring Having Butt Seal, and Method

(71) Applicant: Federal-Mogul Burscheid GmbH, Burscheid (DE)

(72) Inventors: Peter Schmidt, Burscheid (DE); Martin Wenzelburger, Augsburg (DE); Stefan Duerdoth, Burscheid (DE)

(21) Appl. No.: 18/691,930

(22) PCT Filed: Apr. 26, 2022
(86) PCT No.: PCT/EP2022/061020

§ 371 Date: Mar. 14, 2024

(30) Foreign Application Priority Data
Sep. 17, 2021 (DE) 102021124071.9

(51) Int. Cl. F16J 9/20

(52) U.S. Cl. CPC F16J 9/20

(57) ABSTRACT

A compression ring, has a ring running surface (2) on a first butt end region, a ring running surface (2′) on a second butt end region, a ring inner surface (4), a top ring flank surface (6) and a bottom ring flank surface (8), wherein the ring has overlapping first and second butt end regions. The first butt end region has at least one protrusion (10) in the circumferential direction, and the second butt end region has at least one recess (12) in the circumferential direction. The at least one protrusion (10) forms at least one axial and/or radial overlap surface, and the at least one recess (12) forms at least one parallel surface, which lies at least partially opposite to the axial and/or radial overlap surface in order to shift parallel to one another in response to a change of the butt play. At least one of the surfaces, which can be shifted parallel to one another, is provided with an axial wear element (14) and/or with a radial wear element (14′).

### FIELD OF THE INVENTION

The present invention relates to a compression ring, in particular for a large diesel engine piston drive.

### PRIOR ART

Today's 2-stroke crosshead engines are generally equipped with compression rings, which have a so-called gas-tight butt. The term butt is misleading because the combustion gas reaches into the space between first and second compression ring via the axial and radial gaps of the butt. The hot combustion gas transports particles from the combustion. If the axial and the radial clearance is greater than 0, this leads to a strong abrasive wear on the sealing surfaces of the two butt ends, which, downstream, can lead to a release of the running surface layer and this leads to a failure of the system. It is thus important to design the axial and radial gap as small as possible.

The mechanical production of compression rings of this type is complex because the rings distort during the grinding process and the reject rate for the feature of the axial and radial clearance is thus high. In particular the thermal expansion of the rings and of the cylinders need to furthermore be considered during operation, whereby it is not possible to use, for example, a butt-free compression ring.

Various approaches are already known for how a virtually gas-tight compression ring butt is to be attained by means of partial overlap of protrusions and cut-outs on the butt. In the case of these embodiments, however, the problem is that each step and each contact surface has to be manufactured very precisely and the thermal expansions, as they appear during the start-up and during load changes, must not lead to an increased wear or even a destruction of sealing structures, which are present. Sealing structures of this type are known, for example, from the Austrian patent application AT 85885 B or the European patent application EP 3 096 044 A1.

### SUMMARY OF THE INVENTION

According to a first aspect, the invention relates to a compression ring, comprising a ring running surface on a first butt end region, a ring running surface on a second butt end region, a ring inner surface, a top ring flank surface and a bottom ring flank surface, wherein the ring bas overlapping butt end regions, wherein the first butt end region has at least one protrusion in the circumferential direction, and the second butt end region has at least one recess in the circumferential direction, wherein the at least one protrusion forms at least one axial and/or radial overlap surface, and the at least one recess forms at least one parallel surface, which lies at least partially opposite to the axial and/or radial overlap surface in order to shift parallel to one another in response to a change of the butt play, wherein at least one of the surfaces, which can be shifted parallel to one another, is provided with an axial wear element and/or with a radial wear element.

The idea is to introduce a wear element into the axial and/or radial gap of the compression ring in the region of the butt, wherein the axial and/or radial overlap surface of the protrusion lies at least partially opposite the protrusion of the axial and/or radial overlap surface, so that they shift parallel to one another in response to a change of the butt play. At least one wear element for sealing the axial and/or radial ring gap is applied to at least one of these surfaces, which can be shifted parallel to one another, wherein the surfaces, which can be shifted parallel to one another, are configured to shift essentially parallel to one another in response to a change of the butt play, whereby the wear is minimized.

It is preferred that the ring has the overlapping butt end regions in the nominal diameter.

It is preferred that the surfaces, which can be shifted parallel to one another, lie at least partially opposite one another m the nominal diameter.

The nominal diameter or the nominal size, respectively, is the theoretical size, which is provided for the installation of the ring.

It is preferred that the wear element has a minimum thickness of 0.005 mm.

It is preferred that the wear element bas different wear layers arranged one on top of the other, which include different materials.

It is preferred that the material of the wear element has a lower wear resistance than the base material of the ring.

The wear element is made of a temperature-resistant material with a low wear resistance, such as, e.g., copper, tin, bronze or alloys, etc. . . . The softening temperature of this material has to withstand the highest reachable temperatures during the engine operation.

It is preferred that the wear element overlaps or covers, respectively, 10-100% of the surface, on which the wear element is arranged.

It is preferred that the wear element is arranged in the axial direction and/or radial direction at a distance from an edge of the surface, on which the wear element is arranged.

It is preferred that the butt end regions are formed with a single step.

It is preferred that the butt end regions are formed with two steps.

It is preferred that the butt end regions are formed in a staircase-shaped manner.

It is preferred that at least one surface, which lies in a plane, which is spanned by a ring axial and ring radial direction and which is arranged in the second butt end region, has a first structure, which engages with at least one surface, which lies in one plane, which is spanned by a ring axial and ring radial direction and which is arranged in the first butt end region.

An additional seal of the axial ring gap is created thereby. Structures can be aligned, crossing each other and/or orderless, such as, e.g., straight, arcuate or offset in a flat manner, and/or having a roughness Ra, which is 0.2-12.5 μm, preferably 0.4-10 μm, particularly preferably 0.8-6.3 μm.

It is preferred that a strength of the wear element is 1-80%, preferably 1-40%, particularly preferably 1-20% less than a strength of the compression ring.

According to a further aspect, the invention relates to a method for grinding in a compression ring, wherein the method comprises the steps of applying a wear element by means of wire rolling into a groove, laser remelting, laser metal deposition, deposition welding, thermal spraying and/or galvanic or chemical deposition or sintering and moving the butt end regions against one another in order to create a wear of the wear element, until the nominal size in the axial and/or radial direction of the compression ring is reached.

During the operation of the engine, the butt of the ring performns a cyclical, opening and closing movement in the circumferential direction by means of the diameter change via temperature and the temperature-dependent diameter change above the stroke, and will thus grind down the material protruding into the clearance. The wear of the wear element is to be systematic, i.e., it is ground in until the nominal size of the ring in the axial and radial direction is reached.

The material to be introduced is to be introduced at the end of the actual manufacturing process and is to then go beyond the measured axial clearance with at least 0.05 mm without the wear material.

### BRIEF DESCRIPTION OF THE DRAWINGS

Exemplary embodiments of the invention will be described in more detail below with reference to the drawings, wherein

Fig. I shows butt end regions having axial butt seal of the compression ring according to the invention and

FIG. 2 shows butt end regions having axial and radial butt seal of the compression ring according to the invention.

### DETAILED DESCRIPTION OF THE DRAWINGS

FIG. 1 shows butt end regions having axial butt seal of the compression ring according to the invention. The compression ring comprises a ring running surface 2 on a first butt end region, a ring running surface 2′ on a second butt end region, a ring inner surface 4, a top ring flank surface 6 and a bottom ring flank surface 8. A first butt end region has a cuboidal protrusion 10 in the circumferential direction and a second butt end region bas a matching cuboidal recess 12 likewise in the circumferential direction. The protrusion 10 and the recess 12 form an overlap region of two respective opposite surfaces with the same orientation in the axial and radial direction. At least in the nominal diameter or nominal size, respectively, i.e., the theoretical size provided for the installation of the ring, the surfaces lying opposite one another lie at least partially opposite one another. A wear element 14, which does not completely cover the surface, to which it is applied, and which is arranged centrally in the radial direction and offset in the direction of the ring gap in the circumferential direction, is arranged on the surface in recess 12, which is perpendicular to the axial direction. The wear element 14 is additionally arranged spaced apart from the edges of the surface, to which it is applied.

It can further be seen in FIG. 1 that both butt end regions are formed with two steps, wherein a radial dimension of the protrusion 10 corresponds to approximately ⅔ of the radial nominal size of the compression ring and an axial dimension of the protrusion 10 corresponds to approximately ¾ of the axial nominal size of the compression ring. The first butt end region has a first butt end, which corresponds to the highest point of the protrusion 10 and which is located in a plane, which is spanned by a ring axial and ring radial direction. The second butt end region has a surface, which is likewise located in a plane, which is spanned by a ring axial and ring radial direction, but which corresponds to the lowest point of the recess 12. The first butt end as well as the surface lie opposite one another.

The following surfaces can come into surface contact in FIG. 1: the surface on protrusion 10, which is perpendicular to the axial direction, with the surface on recess 12, which is perpendicular to the axial direction, as well as the surface on protrusion 10, which is perpendicular to the radial direction, with the surface on recess 12, which is perpendicular to the radial direction, and the surface on protrusion 10, which is perpendicular to the circumferential direction and which corresponds to the highest point of the protrusion 10. with the surface on recess 12, which is perpendicular to the circumferential direction and which corresponds to the lowest point of the recess 12. The highest point of the recess 12 forms a second butt end and cannot come into surface contact with the opposite surface in the first butt end region because said surface has a curvature.

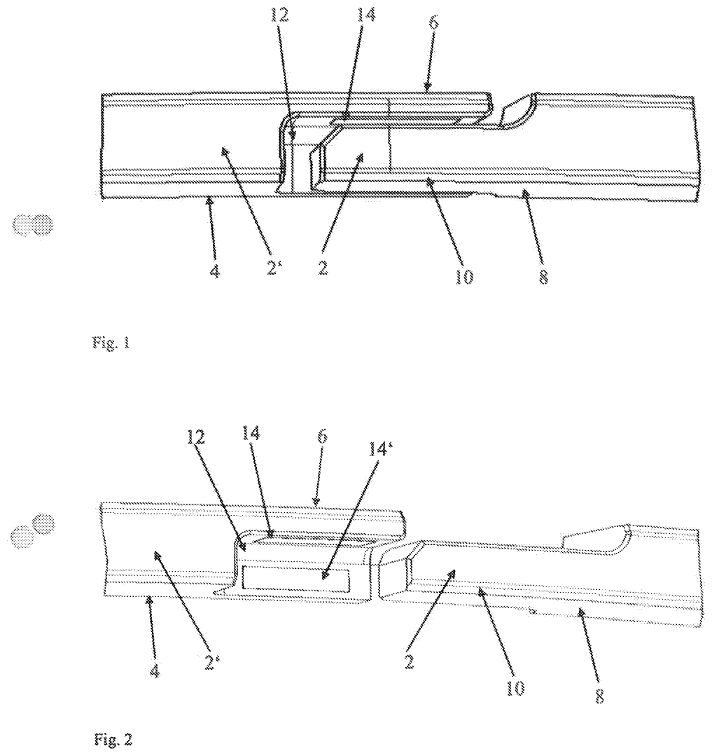

FIG. 2 shows butt end regions having axial and radial butt seal of the compression ring according to the invention. The compression ring comprises a ring running surface 2 on a first butt end region, a ring running surface 2′ on a second butt end region, a ring inner surface 4, a top ring flank surface 6 and a bottom ring flank surface 8. A first butt end region has a cuboidal protrusion 10 in the circumferential direction, and a second butt end region has a matching cuboidal recess 12 likewise in the circumferential direction. The protrusion 10 and the recess 12 form an overlap region of two respective opposite surfaces with the same orientation in the axial and radial direction. At least in the nominal diameter or nominal size, respectively, i.e., the theoretical size provided for the installation of the ring, the surfaces lying opposite one another lie at least partially opposite one another An axial wear element 14 is arranged on the surface in recess 12, which is perpendicular to the axial direction, and a radial wear element 14′ is arranged on the surface in recess 12, which is perpendicular to the radial direction. Both wear elements 14, 14′ do not completely cover the surface, to which they are applied, and are arranged on the respective application surface in the radial direction or axial direction, respectively, and centrally on this surface in the circumferential direction. Wear elements 14, 14′ are additionally arranged spaced apart from the edges of the surface, to which they are applied.

It can further be seen m FIG. 2 that both butt end regions are formed in two steps, wherein a radial dimension of the protrusion 10 corresponds to approximately ⅔ of the radial nominal size of the compression ring, and an axial dimension of the protrusion 10 corresponds to approximately ¾ of the axial nominal size of the compression ring. The first butt end region has a first butt end, which corresponds to the highest point of the protrusion 10 and is located in a plane, which is spanned by a ring axial and ring radial direction. The second butt end region has a surface, on which a plane is located, which is likewise spanned by a ring axial and ring radial direction, but which corresponds to the lowest point of the recess 12. The first butt end as well as the surface lie opposite one another.

The following surfaces can come into surface contact in FIG. 2: the surface on protrusion 10, which is perpendicular to the axial direction, with the surface on recess 12, which is perpendicular to the axial direction, the surface on protrusion 10, which is perpendicular to the radial direction, with the surface on recess 12, which is perpendicular to the radial direction, and the surface on protrusion 10, which is perpendicular to the circumferential direction and which corresponds to the highest point of the protrusion 10. with the surface on recess 12, which is perpendicular to the circumferential direction and which corresponds to the lowest point of the recess 12. The highest point of the recess 12 forms a second butt end and cannot come into surface contact with the opposite surface in the first butt end region because said surface has a curvature.

### LIST OF REFERENCE NUMERALS

2 ring running surface on first butt end region
2′ ring running surface on second butt end region
4 ring inner surface
6 top ring flank surface
8 bottom ring flank surface
10 protrusion
12 recess
14 axial wear element
14′ radial wear element

14. A compression ring, comprising:
a ring running surface on a first butt end region,
a ring running surface on a second butt end region,
a ring inner surface.
a top ring flank surface and
a bottom ring flank surface.
wherein the ring has overlapping butt end regions,
wherein the first butt end region has at least one protrusion in the circumferential direction, and the second butt end region has at least one recess in the circumferential direction,
wherein the at least one protrusion forms at least one axial and/or radial overlap surface, and the at least one recess forms at least one parallel surface, which lies at least partially opposite to the axial and/or radial overlap surface in order to shift parallel to one another in response to a change of the butt play,
wherein at least one of the surfaces, which can be shifted parallel to one another, is provided with an axial wear element and/or with a radial wear element,
wherein the wear element is made of a temperature-resistant metallic material,
wherein the material of the wear element has a lower wear resistance than the base material of the compression ring.

15. The compression ring according to claim 14, wherein the ring has the overlapping butt end regions in the nominal diameter.

16. The compression ring according to claim 14, wherein the surfaces, which can be shifted parallel to one another, lie at least partially opposite one another in the nominal diameter.

17. The compression ring according to claim 14, wherein the wear element has a minimum thickness of 0.005 mm.

18. The compression ring according to claim 14, wherein the wear element has different wear layers arranged one on top of the other, which include different materials.

19. The compression ring according to claim 14, wherein the wear element overlaps or covers, respectively, 10-100% of the surface, on which the wear element is arranged.

20. The compression ring according to claim 14, wherein the wear element is arranged in the axial direction and/or radial direction at a distance from an edge of the surface on which the wear element is arranged.

21. The compression ring according to claim 14, wherein the butt end regions are formed with a single step.

22. The compression ring according to claim 14, wherein the butt end regions are formed with two steps.

23. The compression ring according to claim 14, wherein the butt end regions are formed in a staircase-shaped manner.

24. The compression ring according to claim 14, wherein at least one surface, which lies in a plane, which is spanned by a ring axial and ring radial direction and which is arranged in the second butt end region, has a first structure, which engages with at least one surface, which lies in one plane, which is spanned by a ring axial and ring radial direction and which is arranged in the first butt end region.

25. The compression ring according to claim 14, wherein a strength of the wear element is in the range of 1-80% less than a strength of the compression ring.

26. A method for countersinking a compression ring according to claim 14, wherein the method comprises the steps of:
applying a wear element by means of wire rolling into a groove, laser remelting, laser metal deposition, deposition welding, thermal spraying and/or galvanic or chemical deposition or sintering and
moving the butt end regions against one another in order to create a wear of the wear element, until the nominal size in the axial and/or radial direction of the compression ring is reached.

27. The compression ring according to claim 25, wherein the range is 0-40%.

28. The compression ring according to claim 25, wherein the range is 1-20%.
